(19) United States
(12) Patent Application Publication
(10) Pub. No.: US 2022/0308655 A1
(43) Pub. Date: Sep. 29, 2022

(54) HUMAN-INTERFACE-DEVICE (HID) AND A METHOD FOR CONTROLLING AN ELECTRONIC DEVICE BASED ON GESTURES, AND A VIRTUAL-REALITY (VR) HEAD-MOUNTED DISPLAY APPARATUS

(71) Applicant: City University of Hong Kong, Kowloon (HK)

(72) Inventors: Kening Zhu, Kowloon (HK); Taizhou Chen, Kowloon (HK); Lantian Xu, Shatin (HK); Xianshan Xu, Shatin (HK)

(21) Appl. No.: 17/369,020

(22) Filed: Jul. 7, 2021

Related U.S. Application Data
(60) Provisional application No. 63/165,892, filed on Mar. 25, 2021.

(51) Int. Cl. G06F 3/01; G06F 3/16; G06F 3/0488; G06N 3/08; G02B 27/01

(52) U.S. Cl. CPC G06F 3/011; G06F 3/167; G06F 3/0488; G06N 3/08; G02B 27/017

(57) ABSTRACT

A human-interface-device (HID) for controlling an electronic device, such as a virtual-reality head-mounted display apparatus. The HID includes: a detector module arranged to receive and record a signal associated with a gesture performed by a user; a signal processor arranged to map the recorded signal against a database storing a set of predefined user commands; and a HID controller arranged to execute one or more instructions thereby controlling an operation of the electronic device.

### TECHNICAL FIELD

The present invention relates to a human-interface-device (hid) and a method for controlling an electronic device based on gestures, in particular, but not limited to a gestured-enabled virtual-reality (VR) head-mounted display apparatus.

### BACKGROUND

Besides the high-end VR platforms (e.g., HTC Vive and Oculus), the smartphone-based VR HMDs are also very popular. With more than 3 billion smartphone users in the world, the mobile VR platforms have brought VR to the masses. On the other hand, although a smartphone today could provide powerful computational and rendering capabilities, the interactivity of a low-cost mobile VR HMD is still limited.

A common input method for these HMDs is to leverage the phone's built-in motion sensor and map the user's head rotation/orientation to the looking direction in VR. Besides, the first-generation Google Cardboard allows the user to slide an attached magnet on the side, which can be sensed by the in-phone magnetic sensor, to trigger an input event. In the second-generation Google Cardboard, a small lever button in contact with the phone's touchscreen is integrated to support the button-like input. However, due to the limitation in these buttons or motion sensors, it is difficult for a user to accurate providing complex command to control the operation of the VR HMDs, or the number of commands are relatively limited.

### SUMMARY OF THE INVENTION

In accordance with a first aspect the present invention, there is provided a method of controlling an electronic device based on gestures, comprising the steps of: recording a signal received by a detector module associated with a gesture performed by a user; mapping the recorded signal against a database storing a set of predefined user commands; and executing one or more instructions thereby controlling an operation of the electronic device.

In an embodiment the first aspect, the signal includes an acoustic signal.

In an embodiment the first aspect, the gesture includes at least one of touching, tapping, swiping and drawing a predetermined pattern on one or more interface surfaces.

In an embodiment the first aspect, the acoustic signal is generated by the one or more interface surfaces and is further detected by one or more microphones.

In an embodiment the first aspect, the one or more interface surfaces includes one or more of a front surface, a left surface and the right surface of a housing of the electronic device.

In an embodiment the first aspect, the acoustic signal is generated by at least one of clapping hands and snapping fingers which generates acoustic signal detectable by the one or more microphones.

In an embodiment the first aspect, the step of recording the signal comprise the step of recording a first acoustic signal and a second acoustic signal detected at each of a left side and a right side of the electronic device.

In an embodiment the first aspect, the step of mapping the recorded electronic signal against a database storing a set of predefined user command comprises the step of processing the recorded signal using a deep neural network trained with the set of predefined user commands and previously recorded signals.

In accordance with a second aspect the present invention, there is provided a human-interface-device (HID) for controlling an electronic device, comprising: a detector module arranged to receive and record a signal associated with a gesture performed by a user; a signal processor arranged to map the recorded signal against a database storing a set of predefined user commands; and a HID controller arranged to execute one or more instructions thereby controlling an operation of the electronic device.

In an embodiment the second aspect, the signal includes an acoustic signal.

In an embodiment the second aspect, the gesture includes at least one of touching, tapping, swiping and drawing a predetermined pattern on one or more interface surfaces.

In an embodiment the second aspect, the acoustic signal is generated by the one or more interface surfaces and is further detected by one or more microphones.

In an embodiment the second aspect, the one or more interface surfaces includes one or more of a front surface, a left surface and the right surface of a housing of the electronic device.

In an embodiment the second aspect, the electronic device includes a virtual-reality (VR) head-mounted display apparatus.

In an embodiment the second aspect, the acoustic signal is generated by at least one of clapping hands and snapping fingers which generates acoustic signal detectable by the one or more microphones.

In an embodiment the second aspect, the detector module comprises a first microphone and a second microphone arranged to record a first acoustic signal and a second acoustic signal detected at each of a left side and a right side of the electronic device.

In an embodiment the second aspect, the first microphone and the second microphone are mounted on the left side and the right side of the electronic device.

In an embodiment the second aspect, the detector module comprises a stereo microphone or an array of microphones arranged to record a first acoustic signal and a second acoustic signal detected at each of a left side and a right side of the electronic device.

In an embodiment the second aspect, the signal processor is arranged to process the recorded signal using a deep neural network trained with the set of predefined user commands and previously recorded signals.

In accordance with a third aspect the present invention, there is provided a virtual-reality (VR) head-mounted display apparatus comprising: a housing adapted to be mounted to the head of a user; and a HID in accordance with the second aspect.

In an embodiment the third aspect, the detector module comprises one or more microphones arranged to record a first acoustic signal and a second acoustic signal detected at each of a left side and a right side of the housing, and wherein the first acoustic signal and the second acoustic signal are generated upon the user performing the gesture.

In an embodiment the third aspect, the gesture includes at least one of touching, tapping, swiping and drawing a predetermined pattern on one or more surfaces of the housing, and/or at least one of clapping hands and snapping fingers which generates acoustic signal detectable by the one or more microphones.

In an embodiment the third aspect, the one or more microphones includes a stereo microphone, an array of microphones or a pair of microphones each being mounted respectively on the left side and the right side of the housing.

The term “comprising” (and its grammatical variations) as used herein are used in the inclusive sense of “having” or “including” and not in the sense of “consisting only of”.

It should be understood that alternative embodiments or configurations may comprise any or all combinations of two or more of the parts, elements or features illustrated, described or referred to in this specification.

Any reference to prior art contained herein is not to be taken as an admission that the information is common general knowledge, unless otherwise indicated. It is to be understood that, if any prior art information is referred to herein, such reference does not constitute an admission that the information forms a part of the common general knowledge in the art, in any other country.

As used herein, the term “and/or” includes any and all possible combinations or one or more of the associated listed items, as well as the lack of combinations when interpreted in the alternative (“or”).

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting. Where specific integers are mentioned herein which have known equivalents in the art to which this invention relates, such known equivalents are deemed to be incorporated herein as if individually set forth.

### BRIEF DESCRIPTION OF THE DRAWINGS

Details and embodiments of the indoor navigation method and system will now be described, by way of example, with reference to the accompanying drawings in which:

FIG. 1A is an illustration showing a method of controlling an electronic device based on gestures in accordance with embodiments of the present invention, the electronic device is a virtual-reality head-mounted display apparatus, these “GestOnHMD-enabled” gestures are performed on the left, the right, and the front surfaces of the device respectively;

FIGS. 1B to 1D are images showing application scenarios of GestOnHMD-enabled gesture interaction for mobile VR and the virtual-reality head-mounted display apparatus in accordance with embodiments of the present invention, FIG. 1B shows “Next Video for Video Playback”; FIG. 1C shows “Move Forward for Street-view Navigation” and FIG. 1D shows “Jump for Mobile Gaming”;

FIG. 2 is an illustration showing user-defined on-surface gesture set for each surface, the grey background highlights the remaining gestures after the user-preference-based filtering;

FIG. 3 is a plot showing average ratings of the 50 gestures in terms of simplicity, social acceptability, and fatigue (reversed), the grey background indicates the remaining gestures after the user-preference-based filtering;

FIG. 4 is an illustration showing an example system pipeline of GestOnHMD implemented in an HID controller, and in this example, 3 different VGG19 models have been trained for gesture classification for the front, the left, and the right surfaces, and the corresponding weight parameters of the VGG19 network will be loaded according to the face label;

FIGS. 5A and 5B show confusion matrices of the gesture classification on the left and the right surfaces respectively;

FIG. 6 shows confusion matrix of the gesture classification on the front surface.

FIGS. 7A and 7B are plots showing gesture-classification performance after transfer learning with the three left-out users' data with respectively 5 training samples and 10 training samples for each gesture from each left-out user;

FIG. 8 is an illustration showing the gesture-referent mapping generated in Study 3 for video play and web browsing in mobile VR; and

FIG. 9 is an illustration showing the gesture-referent mapping generated for other referents.

### DETAILED DESCRIPTION OF THE PREFERRED EMBODIMENT

The present invention relates to a human-interface-device (hid) and a method for controlling an electronic device based on gestures, in particular, but not limited to a gestured-enabled virtual-reality (VR) head-mounted display apparatus.

In one preferred embodiment, the invention employs a gesture-based interaction technique and a gesture-classification pipeline that leverages the stereo microphones in a commodity smartphone to detect the tapping and the scratching gestures on the front, the left, and the right surfaces on a mobile VR headset.

The inventors, through their own research, trials and experiments, devised that various solutions may be used to enhance the interactivity of low-cost Cardboard-style VR HMDs, such as installing the touch panels and other interactive widgets on the HMD surfaces, enabling voice-based interaction, enabling magnet-based gestures, tapping detection based on the built-in motion sensor's signal, mid-air tracking using the phone's rear camera and microphone, and eye-tracking using electrooculography sensors and front camera. While these solutions could enrich the interactivity of low-cost smartphone-based headsets, most of them require the installation of extra hardware (e.g., biometric sensors, touch panels, and earbuds) or external passive accessories (e.g. magnets, mirrors, and reflective markers).

Without wishing to be bound by theory, while it was possible to detect on-HMD tapping based on the built-in motion-sensor data, its low sampling rate limited the capability of recognizing complex gestures. Voice-based interaction may yield users' concern on privacy and social acceptance. Though mid-air gestures could be recognized by the rear camera, mid-air interaction may suffer from the fatigue problem due to the lack of physical anchor.

Besides the aforementioned techniques, the inventor devised that acoustic signal may be adopted for inferring human activities. Preferably, sound induced by a surface gesture could be captured at a high sampling rate, without the need of extra external hardware.

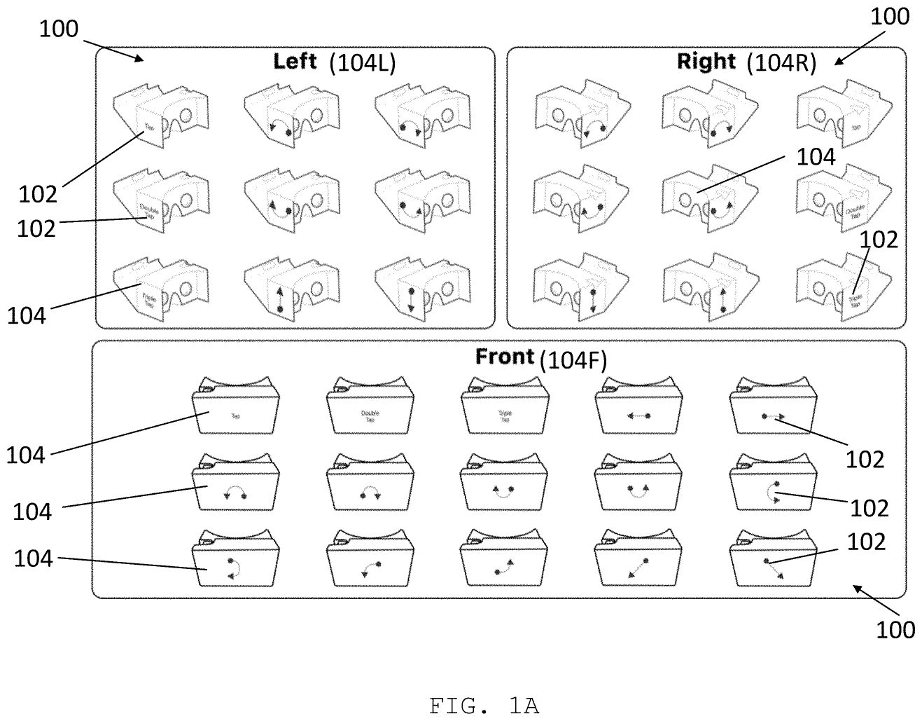

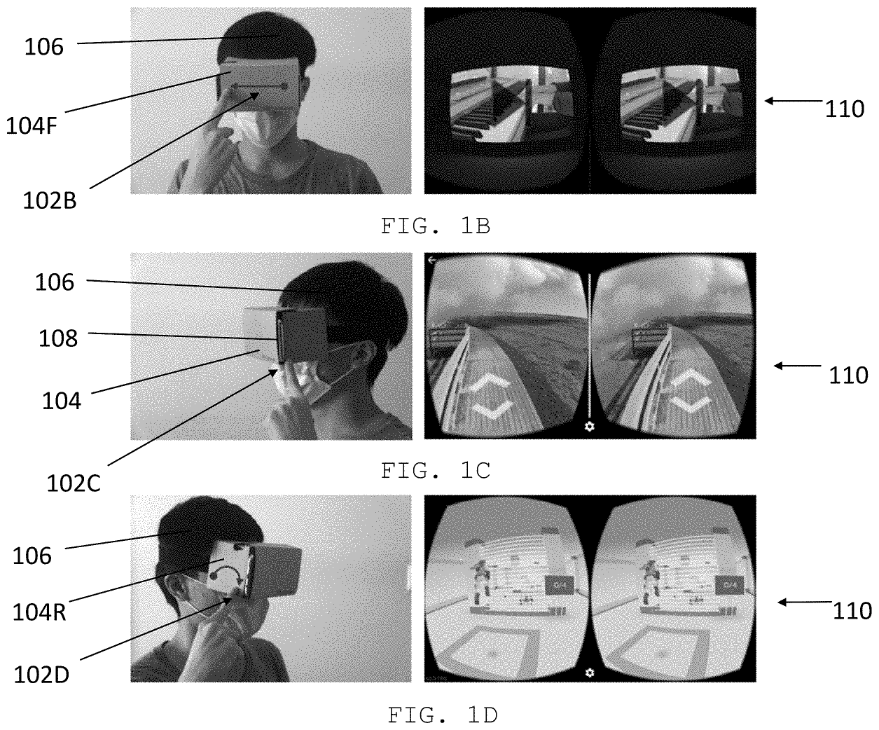

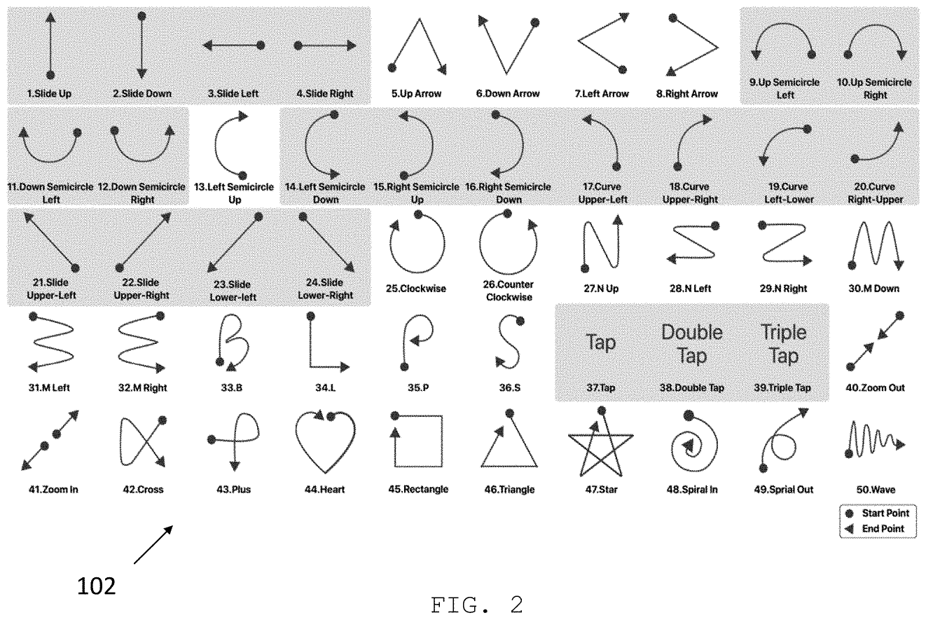

With reference to FIGS. 1 to 9, there is provided a novel method called “GestOnHMD”, which is a gesture-based interaction technique and a deep-learning-based pipeline that leverages the acoustic signal from the built-in stereo microphones in commodity smartphones for gesture recognition on the front, the left, and the right surfaces on the paper-based mobile VR headset.

Referring to FIG. 1A, there is shown an embodiment of a method of controlling an electronic device 100 based on gestures, comprising the steps of: recording a signal received by a detector module associated with a gesture 102 performed by a user; mapping the recorded signal against a database storing a set of predefined user commands; and executing one or more instructions thereby controlling an operation of the electronic device 100.

In this example, the gestures 102 includes at least one of touching, tapping (single or multiple times), swiping (in different directions) and drawing a predetermined pattern on one or more interface surfaces, including the left surface 104L, the right surface 104R and a front surface 104F of the housing 104 of a VR head mounted display (HMD) apparatus which operates as the electronic device 100. One example of HMD apparatus is the Google Cardboard, although the method may also be used in other HMD apparatus with a housing 104 defining these interface surfaces.

Taking Google Cardboard as an example. With a three-step pipeline of deep-learning models, GestOnHMD classified the acoustic signal induced by the user's finger moving on the surface of Google Cardboard. First, a gesture-elicitation study was conducted to generate 150 user-defined on-surface gestures, 50 for each surface. Then the gesture sets were narrowed down to 15, 9, and 9 gestures for the front, the left, and the right surfaces respectively based on user preferences and signal detectability, referring to FIG. 1.

The inventors collected a data set containing the acoustic signals of 18 users performing these gestures (Data set available at: https://github.com/taizhouchen/GestOnHMD), then trained a set of deep-learning classification models for gesture detection and recognition. According to the on-PC experiments, the GestOnHMD pipeline achieved an overall accuracy of 98.2% for both gesture detection and surface recognition, and 97.7% for gesture classification. The inventor further conducted a series of online participatory design studies to generate the mapping between the GestOnHMD-enabled gestures and the commands in common mobile VR applications (e.g., web browsing, video play, gaming, online shopping, and so on).

Preferably, the GestOnHMD combines the techniques of enriching the interactivity for mobile VR and audio-based gesture/activity recognition.

For example, interaction method of mobile VR may use the head rotation sensing by the built-in motion sensors of a smartphone. Enhancing head-based interaction in mobile VR may involve different approaches, such as tilting-based spatial navigation, head-movement-based gestures, head-based text entry, and so on. To support the eye/gaze-based interaction in Google Cardboard, one approach is to embed two Electrooculography sensors at the nose position of the Cardboard, to detect the eye-based gestures, such as blinking and up/down eye movement. Alternatively, an eye-tracking technique using the phone's front-facing camera while being placed in the mobile VR headset may be adopted. However, head/eye-based interaction in VR may induce neck fatigue.

To support the hand-based interaction in mobile VR, ScratchVR which used an irregular circular track in the inner cardboard layer and provide rich haptic feedback while a user is moving the magnet may be employed. PAWdio, a 1-degree-offreedom (DOF) hand input technique that uses acoustic sensing to track the relative position of an earbud that the users hold in his/her hand from a VR headset, may be used. Using the back-facing camera on the phone, FistPointer may be used instead, which detects the gestures of thumb pointing and clicking. Similarly, the finger-pointing direction for target selection in mobile VR may be used. To further leverage the capability of the back camera on the phone, MeCap may be used by installing a pair of hemi-spherical mirrors in front of the mobileVRheadset. It estimates the user's 3D body pose, hand pose, and facial expression in real time by processing the mirror-reflection image. FaceTouch with a touch-sensitive surface on the front surface of the VR headset may be used to support multitouch in VR. Extending the concept of Face-Touch, FaceWidgets integrates various types of electronic input components on the VR headset. For mobile VR settings, and ExtensionClip uses conductive materials to extend the phone's touch-sensitive area to the Cardboard.

In addition, the interaction technique of using motion sensors is also considered. CardboardSense detects the user's finger tapping at different locations (i.e., left, right, top, and bottom) of the Cardboard device according to the built-in motion sensors' data. Similarly, on processing the data of the built-in motion sensors, VR-STEP supports the walking-in-place locomotion in mobile VR. Alohomora is a motion-based voice-command detection method for mobile VR, it detects the headset motion induced by the user's mouth movement while speaking the keywords.

Furthermore, smartwatch could be another add-on component for enriching the interactivity of mobile VR. For example, a smartwatch may be used to detect eye-free touch gestures for text input in mobile VR. WatchVR is another option to support target selection in mobile VR using a smartwatch. It is shown that the pointing gesture induced by the watch's motion significantly reduced the selection time and error rate. Alternatively, the application of bezel-initiated swipe on a circular watch may be used for typing and menu selection in mobile VR.

While the examples above offered various valid options for enriching the interactivity in mobile VR, most of them require the installation of external hardware or accessories. Voice-based interaction with the built-in microphones may yield concerns on privacy and social acceptance, and mid-air gestures may cause fatigue.

However, on-surface gesture interaction for mobile VR may be more preferable in some applications. In GestOnHMD, the user-defined gestures on the surfaces of Google Cardboard for mobile VR may be realized. Preferably, GestOnHMD comprises a three-step deep-learning pipeline for real-time acoustic-based gesture detection and recognition.

Audio signal may capture the information of a user's activity and context. In an example of sound-based gesture recognition, Scratch Input is an acoustic-based gestural input technique that relies on the unique sound profile produced by a fingernail being dragged over the textured surface. Scratch Input may also be applied on gesture recognition using the technique of passive acoustic sensing. For example, EarBuddy is a real-time system which leverages the microphone in commercial wireless earbuds to detect tapping and sliding gestures near the face and ears, it employs a DenseNet-based deep-learning model which can recognize 8 gestures based on the MFCC (Mel-frequency cepstral coefficients) profiles of the gesture-induced sounds with an average accuracy over 95%.

The acoustic signal can also infer the user's activity and context. For example, SoundSense uses the classic machine-learning techniques to classify ambient sound, music, and speech with an overall accuracy above 90%. Alternatively, the MFCC features may be processed with non-Markovian ensemble voting to recognize 22 human activities within bathrooms and kitchens. BodyScope uses the Support-Vector-Machine model to classify 12 human activities, and achieved an accuracy of 79.5%. Alternatively, BodyBeat classifies 8 human activities with the Linear Discriminant Classifier. Lamello employs a set of 3D-printed tangible props that can generate unique acoustic profiles while the user moving the embedded passive parts. In another example, custom hardware may also be used to distinguish 38 environmental events by processing MFCCs with a pre-trained neural network.

Preferably, GestOnHMD builds on the idea of gesture recognition based on passive acoustic sensing, with the focus on enabling on-surface gestures for mobile VR headsets. A three-step pipeline of deep-learning neural networks has been developed to classify 33 example gestures on the surfaces of Google Cardboard.

With reference To FIGS. 1B to 1D, there is shown an example application of a VR HMD apparatus 100 mounted to a head of a user 106. In this example, the VR HMD apparatus 100 includes a housing 104, which may be a cardboard device defining a front surface 104F, a left surface 104L and the right surface 104R with respect to the first-person view (FPV) of the user 106, and an mobile device such as a smartphone 108 having an electronic display 110 and the necessary optical components to provide an immersive visual experience to the user 106 when the VR HMD apparatus 100 is mounted to the head of the user 106. Alternatively, the housing, the display panel and/or other components such as microphones, speakers, connectors or switches, etc. may be otherwise provided to combine as a dedicated device which may be specifically manufactured for used as the VR HMD apparatus.

Preferably, the gesture 102 includes at least one of touching, tapping, swiping and drawing a predetermined pattern on one or more interface surfaces. For example, FIG. 18 shows a gesture 102B for triggering a user command of “Next Video for Video Playback”, the gesture 102B combines touching the front surface 104F of the housing and then swiping to the right; FIG. 1C shows a gesture 102C for triggering a user command of “Move Forward for Street-view Navigation”, the gesture 102C is simply to tap the left bottom corner of the housing 104 once or multiple times; and FIG. 1D shows “Jump for Mobile Gaming”, the gesture 102D combines touching the right surface 104R of the housing followed by drawing an inverted U-shaped on the surface.

Also referring to FIG. 2, the gesture 102 may further includes other combinations of touching, tapping, swiping and drawing a predetermined pattern on one or more interface surfaces, such as but not limited to drawing one or more straight lines in Examples, 1, 2, 3, 4, 5, 6, 7, 8, 21, 22, 23, 24, 27, 28, 29, 30, 31, 32 and 34; drawing one or more curve lines in Examples, 9, 10, 11, 12, 13, 14, 1, 16, 17, 18, 19, 20, 25, 26, 33, 35, 36, 49 and 50; drawing letters/symbols such as examples 27, 28, 29, 30, 31, 32, 33, 34, 35, 36, 42 and 43; drawing a known shapes such as examples, 44, 45, 46, 47 and 48 or taping or pinching such as examples 37, 38, 39, 40 and 41, or any other possible combination of touching, tapping, swiping and drawing other patterns.

Preferably, by tapping or drawing the patterns on one of the left, right and front surface, acoustic sounds or signals are generated upon performing these gestures, due to friction and/or percussion between the user's fingers and the interface surface, and the acoustic signal may then be detected by microphone(s) in the smartphone device or embedded in the housing of the VR HMD.

Preferably, the microphones may include a stereo microphone, an array of microphones or a pair of microphones each being mounted respectively on the left side and the right side of the housing. For example, the detector module may comprise a first microphone and a second microphone arranged to record a first (e.g. left) acoustic signal and a second (e.g. right) acoustic signal detected at each of a left side and a right side of the electronic device. Preferably, the microphones are mounted on the left side and the right side of the electronic device, or a stereo microphone may be used to pick up acoustics signals coming from the left side and the right side of the VR HMD apparatus.

The spatial distribution of the microphones may further enhance the accuracy of the recognition of the gestures, for example, by precisely identifying the amplitudes of the signal on the left and the right sides each time when an acoustic signal is recorded. Alternatively or optionally, the device may be calibrated according to the sensitivity of the microphones and the position of the microphones, e.g. when a smartphone is placed in a VR cardboard housing when initializing the VR HMD apparatus.

After recording the acoustic signals associated with the user's gesture, the signal processor is arranged to process the recorded signal using a deep neural network trained with the set of predefined user commands and previously recorded signals. This is further explained later in this disclosure.

The inventor investigated the on-surface gestures that may be preferred by users for common mobile VR applications. It was observed by the inventors that the user-defined gestures could improve the learnability and the usability for gestural user interfaces, and can infer users' general mental model towards a particular interaction contexts. The inventors also investigated on gesture-elicitation by focusing on various types of human-computer interaction (e.g. surface computing, mobile interaction, and augmented reality, etc.), to generate the user-defined gestures. The following gesture-elicitation investigation has been considered to derive a set of user-defined on-surface gestures for a mobile VR headset, here Google Cardboard, and to be classified in the later technical implementation.

In a gesture-elicitation study, a user is usually shown to a set of referents or effects of actions (e.g., the operations in text editing, multimedia browsing, gaming, etc.). The user will then define his/her desired gestures accordingly. In the study, video playback and web browsing were selected, due to their popularity in mobile VR Applications. Referring to the previous related research, 10 referents (Table 1) were selected, covering both action and navigation, for each of these two applications.

TABLE 1
List of referents presented to the participants

| Category | Sub-Category | Task Name |
|---|---|---|
| Action | Video Playback | Play/Pause |
| | | Stop |
| | | Mute/Unmute |
| | | Add to Play List |
| | Web Browsing | New Tab |
| | | Close Tab |
| | | Open Link |
| | | Add Bookmark |
| Navigation | Video Playback | Next Video |
| | | Previous Video |
| | | Volume Up |
| | | Volume Down |
| | | Forward |
| | | Backward |
| | Web Browsing | Next Tab |
| | | Previous Tab |
| | | Next Page |
| | | Previous Page |
| | | Scroll Up |
| | | Scroll Down |

In the experiment/study, twelve participants (4 females and 8 males) were recruited for this study. The average age was 24.6 years old (SD=4.17). One was left-handed. Six were from the professions in engineering and science, four were from art and design, and two were from business and management. Ten participants mentioned that they have used Google Cardboard before, and the applications they used in Google Cardboard include video playback (6), web browsing (3), and game (1).

The participant was provided with a Google Cardboard headset without a smartphone integrated inside. The referents were displayed on a 33″ LCD monitor in front of the participant with the animation playing the effects of actions.

Upon the arrival of a participant, the facilitator introduced the study purpose and asked the participant to fill the pre-study questionnaire for his/her anonymous biographic information, and sign the consent form voluntarily. The facilitator then explained the flow of the experiment, introduced the two selected applications and the referent sets. The participant was asked to design the gestures for the referents to be performed on three surfaces (i.e., front, left, and right) of the Google Cardboard. This resulted in 2 applications_3 surfaces=6 conditions presented in the Latin-square-based counterbalanced order, leading to 6 design blocks for each participant. In each block, the participant was asked to design two gestures for each referent. The participant was told not to use the same gesture for different referents under the same application but allowed to reuse gestures across different surfaces and applications. The study for each participant took around one hour.

With 12 participants, 3 surfaces, 20 referents, and 2 design for each referent on each surface, a total of 12×3×20×2=1440 gestures were collected. The open-coding protocol to group these gestures were adopted according to their shapes so that each group held one identical representative gesture that was clustered across all the participants. This resulted in a set of 50 gestures for each surface as shown in FIG. 2.

With these user-defined on-surface gestures, the inventors further narrow them down to an optimal subset that can be easily learned, naturally performed, and reliably classified. Therefore, an online user-preference survey and a series of acoustic-analysis experiments were conducted to identify a subset of the most preferable gestures.

The inventors first conducted an online questionnaire survey on the user preference towards the 50 user-defined gestures on the three different Cardboard surface. This resulted in 50 gestures×3 surfaces=150 sets of questions. Each set of questions was presented with the gesture images in a random order in the online questionnaire. There were three items for each gesture, for a 7-point Likert-scale rating (1: strongly disagree to 7: strongly agree): (1) Ease to perform: “It is easy to perform this gesture precisely.” (2) Social acceptance: “The gesture can be performed without social concern.” (3) Fatigue: “The gesture makes me tired.”

Online Respondents: The questionnaire was published online and available to the public for one week. The inventors received responses of 30 persons (14 males and 16 females). The average age was 27.5 years old (SD=3.53). Three were left-handed. Twenty-two respondents stated that they have at least 6-month experience of using VR, while eight never used VR before.

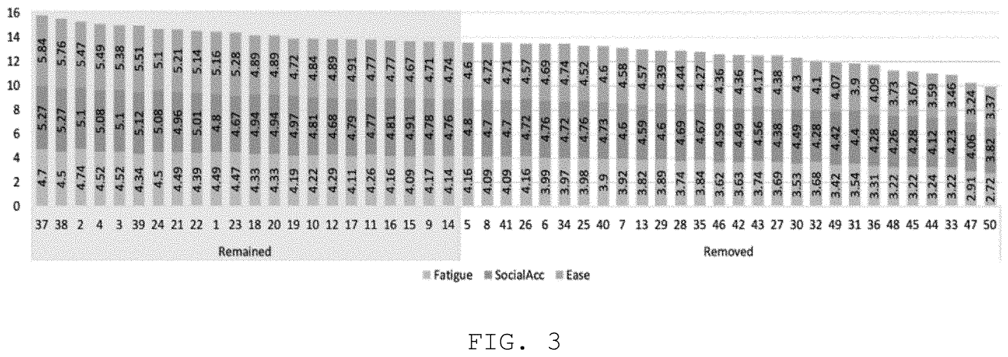

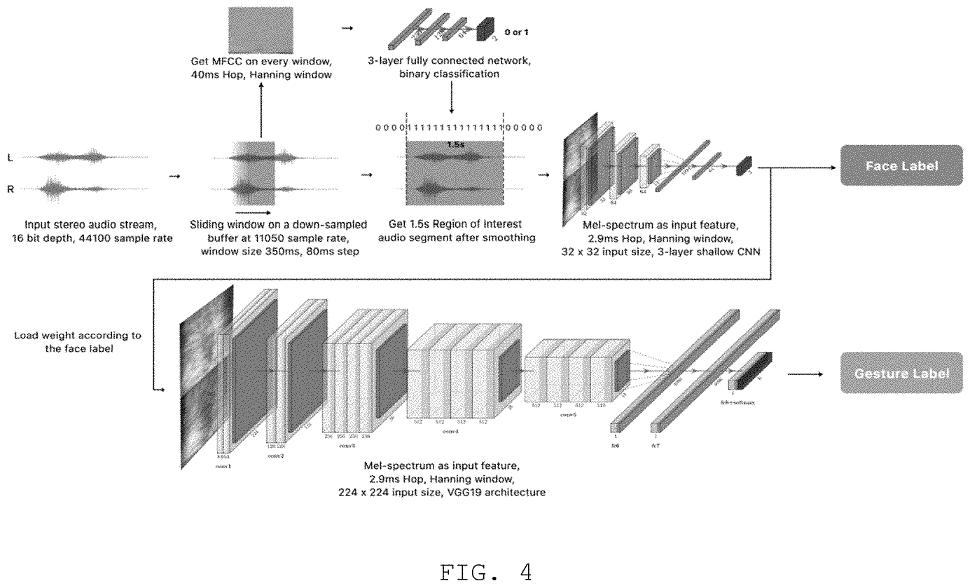

Results: A multi-factorial repeated-measures was performed on the ratings of ease to perform, social acceptance, and fatigue. The results showed a significant effect of the gesture type on the ratings of ease to perform (F(49,1421)=15.22, p<0.005, ηₚ²=0.344), social acceptance (F(49,1421)=6.40, p<0.005, ηₚ²=0.181), and fatigue (F(49,1421)=8.87, p<0.005, ηₚ²=0.234), while there was no significant effect of the surface on these ratings. Therefore, the inventors first averaged the three ratings on the three surfaces for each gesture. FIG. 3 shows the descriptive results of the average ratings for each gesture.

Following the previous practice of preference-based gesture selection, the gestures whose three ratings were all above 4 may be selected. Therefore, the process removed 22 gestures with at least one rating below 4 were eliminated. The design consistency of the gestures may also be considered. Previous research on gesture elicitation showed that users tended to include mirrored/reversible gestures in their gesture sets, especially for dichotomous referents. Preferably, the mirrored and reversible gestures of those that may be further eliminated due to the low ratings, resulting in 22 gestures (highlighted with the grey background in FIG. 2 and FIG. 3) remaining for each surface after this process.

After considering the user preference as the first factor, the remaining gestures were examined according to the signal detectability. The acoustic signals of three persons (the co-authors) performing the 22 remaining gestures were recorded. Each gesture was performed within 1.5 s for 20 repetitions on each surface. In addition, all three persons performed the gestures in the same lab environment where there was a constant background noise of the air conditioner and the fan. There were 10 acoustic signals of pure background noise being recorded, and the average signal were used for signal-to-noise ratio (SNR) calculation. The average noise level was around 50 db. This resulted in 3 persons×22 gestures×3 surfaces×20 repetitions=3960 acoustic signals, with 60 signals for each gesture on each surface.

Signal-to-Noise Ratio Analysis: the SNR may be calculated based on the MFCC images for each sample on the front, the left, and the right surface respectively. The gestures with an average SNR lower than 5 dB may then be removed, which may be a criteria for signal detection. With the consideration of gesture mirroring, this process deleted no gesture for the front surface, 8 gestures for the left surface (i.e., gesture#3, #4, #15, #16, #17, #18, #20, #23 in FIG. 2), and 8 gestures for the right surface (i.e., gesture#3, #4, #14, #16, #18, #19, #22, #23 in FIG. 2). Noted that there was no gesture deleted for the front surface in this step. This could be due to the gestures generating an evenly distributed acoustic signal for the stereo microphones, leading to a considerable level of SNR. For the gestures on the left or right surface, the acoustic signal was likely to be biased to the channel on the corresponding side.

In a Signal Similarity Analysis, the inventors used dynamic time warping (DTW) on the average signal for each gesture, to calculate signal similarity between pairs of gestures within each surface. For each surface, the distance matrix where each cell was the DTW distance across all possible pairs of the corresponding gestures were calculated. Each row is summed to calculate the similarity between each gesture and all others within the same surface. Gestures with total distances lower than the 25th percentile were removed, as they are most likely to be confused in the classification. Doing so with the additional consideration of gesture mirroring removed 7 gestures, 5 gestures, and 5 gestures for the front, the left, and the right surface respectively.

The procedure of gesture selection resulted in 15 gestures for the front surface, 9 gestures for the left surface, and 9 gestures for the right surface, as shown in FIG. 1A.

After finalizing the gesture set for each surface, the inventors experimented with the feasibility of GestOnHMD, through 1) constructing a data set with a variety of instances of the selected gestures, and 2) training the machine-learning models for real-time gesture detection and recognition in the GestOnHMD pipeline.

Preferably, the process of constructing the data set for gesture detection and recognition in GestOnHMD may be involved for initializing the training of the deep neural network.

The inventors recruited 18 participants (6 female and 12 male) from a local university. The average age was 24.7 years old (SD=2.54). Two of them were left-handed, while the rest were right-handed. The data-collection process was done in a sound studio where the average noise level is lower than 30 dB. Participants were provided with a Google Cardboard headset (with the elastic head strap) with a Galaxy S9 integrated inside. A customized mobile VR program was executed on the smartphone for collecting acoustic data. The program was controlled by a Java server that runs on the facilitator's laptop through TCP/IP protocol. Each gesture was recorded as a 1.5-second-length stereo audio clip in 16 bit at the sample rate of 44100 Hz. The participants sit in front of a 45-inch monitor which shows a slide of the to-record gesture's illustration and demo video.

There were one facilitator and one participant in each session. The experiment facilitator first asked the participant to fill the pre-study questionnaire for his/her biographic information and sign the consent form voluntarily. The participant was then told to follow the gesture illustration and the demo video to perform the gestures on the cardboard surface. Before each recording, the inventors first asked the participant to practice the gesture for several times until he/she was comfortable doing so. During the recording of each gesture, the participant first saw a 3-second count-down in the Cardboard, followed by a 1.5-second decreasing circular progress bar. The participant was asked to start performing gestures right after the count-down and finish before the progress bar ended. For each gesture, the participant needed to repeat 20 times. The inventors also asked him/her to take off the headset and take it on again after every 10 times of recording, to increase the data variance. There was a mandatory 5-minutes break after the recording of all the gestures on each surface, and the participant can request for a short break at any time during the session. The order of the surfaces was counterbalanced across all the participants, while the gesture order within each surface was randomly shuffled for every participant. The experiment took about one and a half hours to complete. As a result, 3239 valid audio clips, containing 413,694,118 audio frames in total for 33 gestures were recorded and used in the training set.

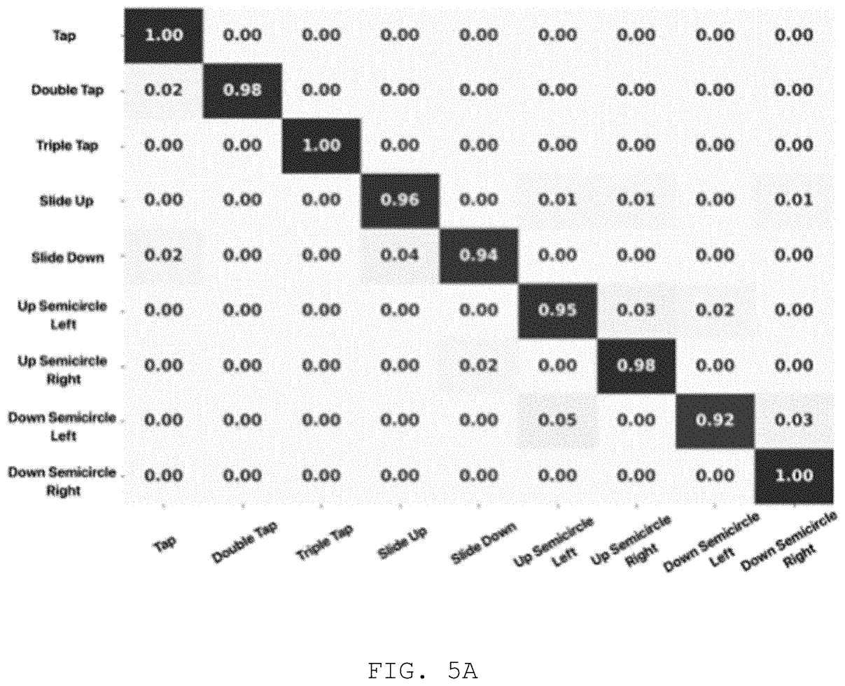

With the collected data set of acoustic gestural signal, GestOnHMD with a three-step deep-learning-based pipeline for on-surface gesture detection and recognition on Google Cardboard is provided. As shown in FIG. 4, the GestOnHMD pipeline first detected whether the user is performing a gesture on the surface of the headset. Once a gesture is detected, the pipeline classified the surface where the gesture is being performed, and then classified what gesture is being performed using the gesture-classification model corresponding to the predicted surface.

The GestOnHMD pipeline first detects whether a gesture has been performed by the user on the surface. To simulate the real-time gesture detection, the sliding-window algorithm was adopted on the recorded audio clip. More specifically, a 350 ms sliding window with 80 steps on a down-sampled audio sample with a sample rate of 11050 Hz was applied. For each window, 20 MFCC features were extracted using a Hanning window in the hop size of 40 ms. For each extracted MFCC feature, its mean and standard deviation were obtained to form a 40-dimensional feature vector and passed the feature vector a 3-layer fully connected network with a binary classifier for gesture detection. The process also involve randomly choosing 3 users' acoustic data of gesture performing (Label: 1), along with the soundtracks of office and street noise (Label: 0) to train the classifier. The resulted gesture-detection classifier achieved an overall accuracy of 98.2%. During detection, a smoothing algorithm may be applied. More specifically, adjacent sequences of continuous positive detection which lasted more than 1.5 seconds may be treated as a valid detection. To reduce the noisy shifting, if a long consecutive positive sequence was separated by one or two negative detections, it may be tolerated and the whole sequence may be treated as a valid detection. As a result, a 1.5 s segment of audio signal with a sequence of positive detection may form as a candidate audio segment for future classification.

For each audio segment from the step of gesture detection, the pipeline performs the process of surface recognition before the gesture classification, to classify on which surface the gesture is performed. The audio segment may be converted to a 32×32 mel-spectrogram image, before feeding into a shallow convolutional neural network (CNN) with 3 convolutional layers and one fully connected layer for surface classification. Since the acoustic signal is recorded in the stereo format, it may encode special features that could be useful for surface recognition. For example, if the gesture was performed on the right surface, the right channel will possibly contain more energy/higher amplitude than the left channel, and vice versa. Thus, the mel-spectrograms may be extracted for both the left and the right channels separately, and may be further concatenated vertically into one image. Lastly the image may be reshaped into 32×32. The model of surface recognition was trained using all data from 18 users by 8-2 train-test split. The overall accuracy is 98.2%.

The audio signal from the step of gesture detection was converted to the format of mel-spectrogram, and used for gesture classification by the pre-trained deep convolution neural network according to its surface label.

To increase the model's generalizability and avoid overfitting during training, the following data-augmentation schemes may be adopted. Each of these schemes was independently applied to the input data during training with a probability of 0.5.

Noise Augmentation: as the raw acoustic data of the gestures is collected in a quiet studio, it may be preferable to simulate the real-world scenario with various background noises. To this end, the inventors randomly mixed the noisy signal from the soundtracks of two common scenarios, office noise 1 and street noise 2 to the raw audio data with a signal-to-noise mixing rate of 0.25 before converting them to the format of mel-spectrogram.

Time Warping. Although the recording duration was set as 1.5 seconds to cover all the selected gestures, the gesture performing speed across different users may vary, which may also lead to overfitting. To this end, the strategy of time warping was applied to augment data along the time domain. More specifically, for each mel-spectrogram image with τ time step where the time axis is horizontal and the frequency axis is vertical, a random point a from the time axis within the time step (W, τ−W) may be picked. Then all points along the horizontal axis with a time step α to the left or right was warped by a distance ω chosen from a uniform distribution from 0 to the time-warping parameter W=80.

Frequency Mask. For each mel-spectrogram image, the technique of frequency masking may be applied so that f consecutive mel-frequency channels [f₀, f₀+f) are masked by their average. f is chosen from a uniform distribution from 0 to the frequency-masking parameter F=27, and f0 is chosen from [0, v−f) where v is the number of mel-frequency channels. Two masks for each mel-spectrogram image may be generated.

Training: the gesture-classification tasks on the three surfaces may be treated as three different classification problems. Through a pilot experiment using three users' data, it was found that treating the recorded audio clip as a mono-channel acoustic signal could effectively increase the classification performance on both the left and the right surfaces, while treating the recorded audio clip as a multi-channel/stereo acoustic signal lead to a better performance for classifying the data on the front surface. Therefore, for the left and the right surfaces, the data of the left and the right channels for all the recorded audio clips may be averaged before converting them to the 224×224 mel-spectrogram images. For the front surface, two mel-spectrogram images for the data of the left and the right channels may be generated respectively, and then vertically concatenated, and lastly reshaped into 224×224.

Three gesture-classification models were trained, one for each of the three surfaces respectively, on a Desktop PC with one GTX 1080 Ti NVIDIA GPU, 32 GB RAM, and one Intel i7-8700 CPU. An Adam optimiser (β₁=0.9, β₂=0.999) may be used with the learning rate of 1e-5 for model optimization. The batch size was set to 16. During training, the dropout technique was applied with the dropout rate of 0.5 to avoid overfitting.

For training the gesture-classification model for each surface, the average signal-to-noise ratio for each user's data is first calculated. The data of three users whose SNR values are three lowest were removed. Then the recorded acoustic data from the remaining 15 participants were shuffled, and separated into an 8-2 train-validation split. The inventors experimented with the gesture classification on the three surfaces with six different structures of convolution neural networks as shown in Table 2, each being trained for 20 epoch. Table 2 shows their performance of gesture classification.

TABLE 2
The performance of GestOnHMD on different models. The accuracy,
precision, and recall are weighted across all gestures.

| Model | Face | Accuracy \| Precision \| Recall |
|---|---|---|
| VGG16 | F | 0.9304 \| 0.9409 \| 0.9227 |
| | R | 0.9741 \| 0.9740 \| 0.9698 |
| | L | 0.9677 \| 0.9717 \| 0.9612 |
| VGG19 | F | 0.9639 \| 0.9755 \| 0.9579 |
| | R | 0.9905 \| 0.9943 \| 0.9905 |
| | L | 0.9792 \| 0.9790 \| 0.9735 |
| DenseNet169 | F | 0.7589 \| 0.9043 \| 0.5904 |
| | R | 0.7936 \| 0.9182 \| 0.6591 |
| | L | 0.7462 \| 0.8727 \| 0.4545 |
| DenseNet201 | F | 0.8449 \| 0.9218 \| 0.7634 |
| | R | 0.9034 \| 0.9272 \| 0.8920 |
| | L | 0.9015 \| 0.9407 \| 0.8712 |
| ResNet50 | F | 0.7366 \| 0.8435 \| 0.6317 |
| | R | 0.7083 \| 0.8788 \| 0.4943 |
| | L | 0.6307 \| 0.7807 \| 0.5057 |
| ResNet101 | F | 0.6261 \| 0.7992 \| 0.4397 |
| | L | 0.6231 \| 0.7746 \| 0.4621 |
| | R | 0.6212 \| 0.8087 \| 0.4242 |

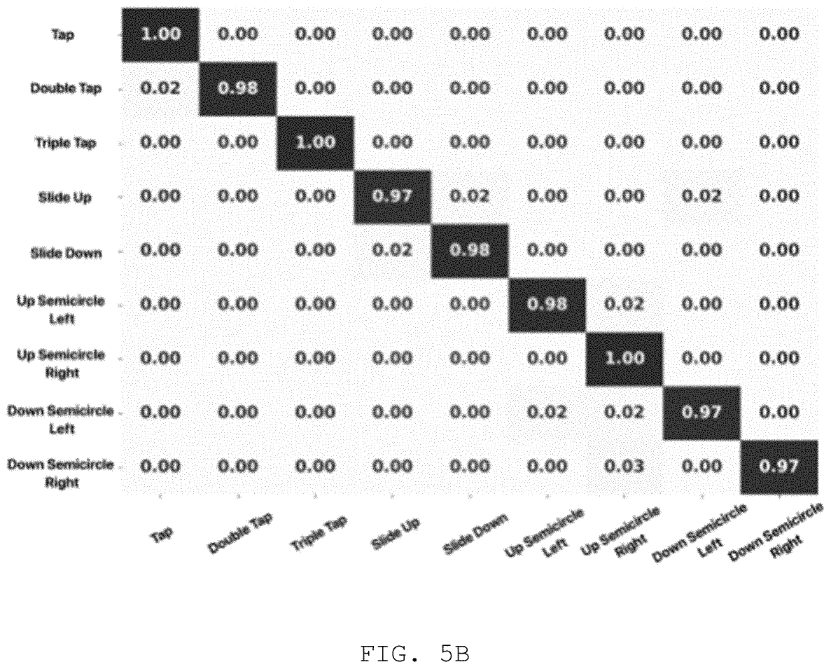

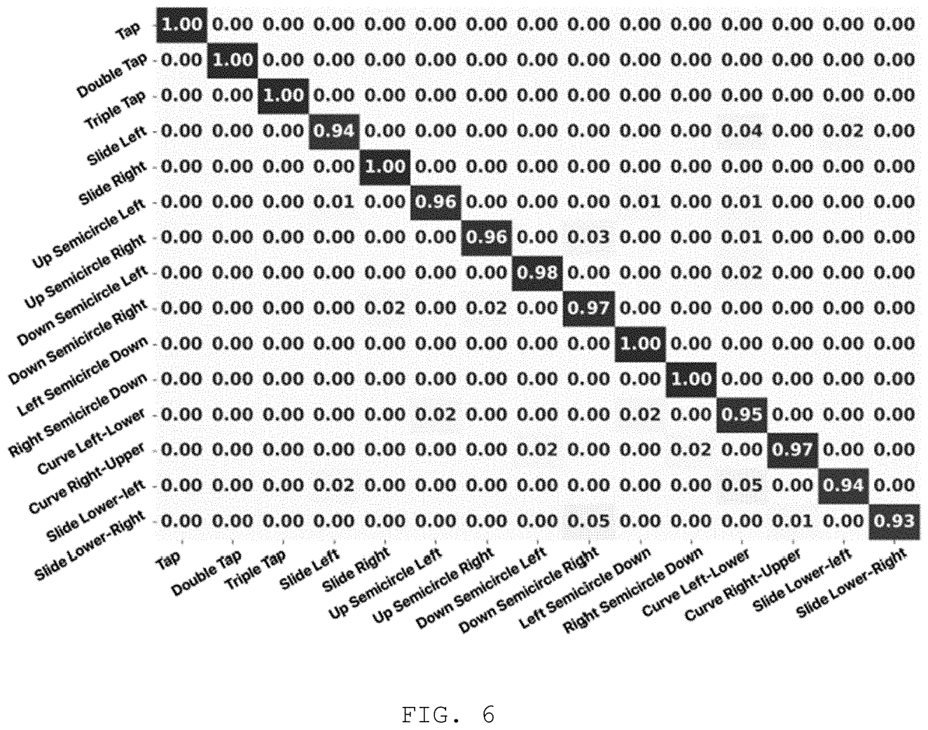

The experiments showed that VGG19 achieved the highest accuracy of gesture classification across the three surfaces. The overall accuracy of VGG19 are 97.9%, 99.0%, and 96.4% for the left, the right, and the front surface respectively. FIGS. 5A, 5B and 6 illustrate the confusion matrices for the gesture classification on the three surfaces with VGG19. As shown in FIGS. 5A and 5B, for the right and the left surface, three tapping-based gestures perform the best (averagely over 99.0% for both left and right), followed by four semicircle-based gestures (averagely 98.0% on the right surface, and 96.0% on the left surface). Two sliding-based gestures yielded the lowest accuracy (Right: 97.5%, Left: 95.0%). For the front surface, three tapping-based gestures achieved the highest accuracy of 100.0%. Six semicircle-based gestures and two left-right slide gestures yielded the same average accuracy of 97.0%, followed by two curved-based gestures (96.0%). Slide lower-left and slide lower-right yielded the lowest average accuracy (93.0%).

Leave-Three-User-Out Experiments: fFor the performance experiments of different classification models, the user data of the top three lowest SNR, and used the data of the remaining 15 users for training and testing were eliminated. However, the eliminated data of the three users may represent a specific range of on-surface gesture patterns. To investigate the generalizability of the trained gesture-classification model, the data of the left-out users were also tested. This revealed an overall accuracy of 76.3%, 87.4%, and 93.7% for the front, the left, and the right surface respectively. There was an average drop of 12.0% from the within-user test, with a large drop around 20% for the gestures on the front surface.

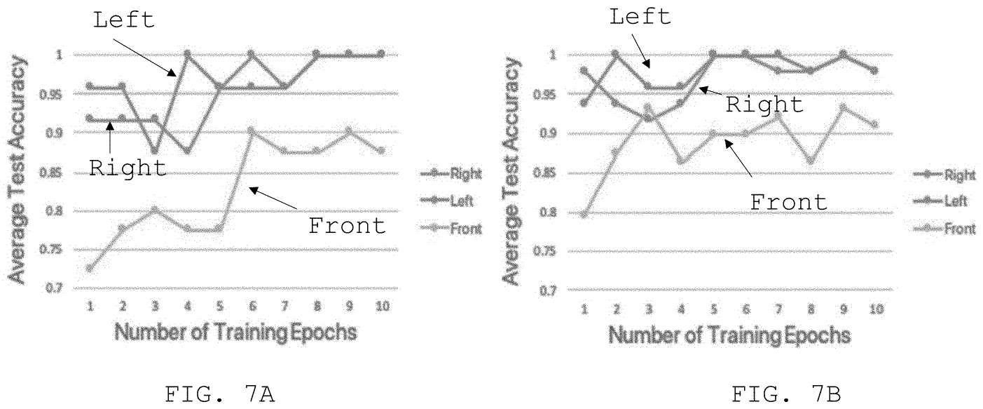

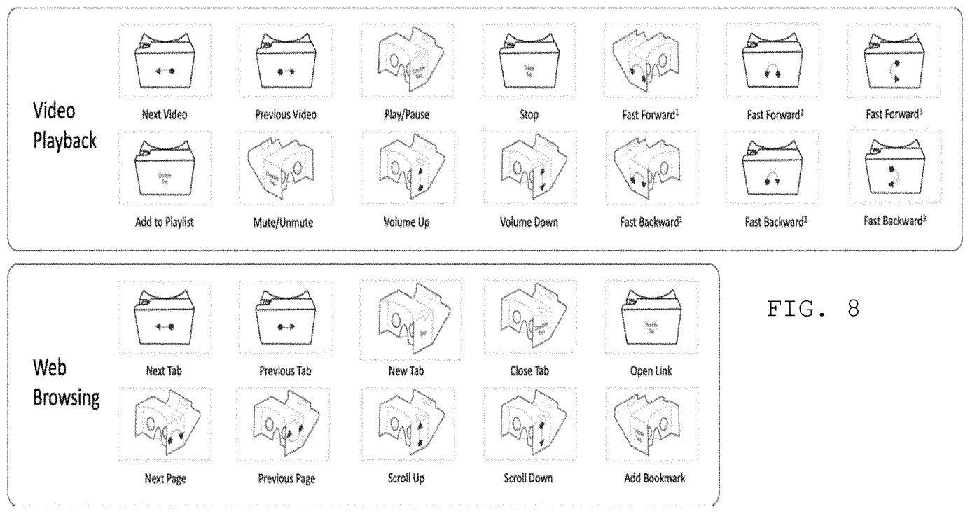

In a real-world scenario, many applications often ask a new user to perform and practice each gesture for a few times before the actual usage. The recorded gestures can be used for transfer learning on a pre-trained model. To this end, the transfer-learning process were experimented on the trained VGG19 models with a small amount of data from the three left-out users. FIGS. 7A and 7B show how the amount of training data included from the left-out users could improve the gesture-classification performance on the three surfaces. With a minimum amount of five samples for each gesture from each user, the overall performance improved to 96.7% averagely.

Real-time Performance: to evaluate the real-time efficiency of GestOnHMD, the three-step pipeline may be implemented using Python 3.5 with TensorFlow 2.2 framework on a desktop PC with the same specification of the computer used for model training. The pipeline received the real-time audio stream from the smartphone through a TCP/IP protocol. The total inference time for the three-step pipeline was 1.96 s, indicating an acceptable response speed of GestOnHMD.

With the considerable performance of gesture recognition in GestOnHMD, the inventors further investigated how the gesture set enabled by GestOnHMD could be used for mobile VR applications. The inventors conducted a series of online participatory sessions, by inviting mobile VR users to create the mapping between the GestOnHMD-enabled gestures and the operations in mobile VR.

Through the word of mouth and the advertisement on social network, 19 participants (6 females and 13 males) were recruited. The average age was 25.2 years old (SD=3.52). Two were left-handed. Nine stated that they have at least 6-month experience of using VR, and five stated they have <6-month experience of using VR, while six never used VR before. All the participants were in the same region as the authors.

The participatory design sessions were conducted in the format of online video conferencing using Zoom. Before the scheduled session, a set of Google Cardboard with the elastic head strap was sent to the participant through the local post. The participant was told to use the Google Cardboard during the design session. On the side of the experiment facilitator, the prototype of GestOnHMD was set up for demonstration. The inventors used the 20 referents from the two mobile VR applications used in Study 1 (i.e. video playback and web browsing). For each referent, the participant was asked to assign one GestOnHMD-enabled gesture that he/she felt the most suitable. The gesture cannot be reused for different referents within the same application, but can be reused across different applications. The applications were presented in a Latin-squared-based counterbalanced order across all the participants, and the order of the referents under the same application was randomized.

There were one facilitator and one participant in each session. The facilitator first guided the participant to fill the pre-study questionnaire for his/her anonymous biographic information, and sign the consent form voluntarily. The facilitator then presented the flow of the study, and introduced the think-aloud protocol to encourage the participant to verbally describe his/her thinking process. In addition, the facilitator instructed the participant to try Google Cardboard by installing the common applications, such as Youtube and VR web browser, on the participant's phone. The facilitator then demonstrated GestOnHMD by randomly selecting three gestures from each surface for demonstration. After the demonstration, the participant started the process of gesture-referent mapping. There were two design blocks, one for each application, in each participant session. In each block, the facilitator shared the screen of a mapping questionnaire. The participant verbally described the mappings, and the facilitator dragged and dropped the gestures image to the corresponding referents for confirmation. The participant can modify the mappings freely until he/she was satisfied. After the two design blocks, the facilitator instructed the participant to propose at least three pairs of mappings between the GestOnHMD-enabled gestures and the referents from other VR applications. The whole session took around 1 hour, and was video recorded with the prior consent of the participant.

In total of 360 pairs of gesture-referent mappings from all the participants were collected. For each GestOnHMD gesture, its number of being used in each referent (i.e. appearance frequency) is calculated. As one gesture could be mapped to different referents in the same application, for each gesture, the referent is selected for which the gesture achieved the highest appearance frequency as the first step of deriving the final mappings. However, the conflict may still exist as multiple gestures could be mapped to one referent by different participants. To resolve this, the gesture with the highest appearance frequency within one referent won. Lastly, it is possible that multiple gestures achieved the same appearance frequency which was the highest within one referent. In this case, all the gestures were kept. The inventors also considered the design consistency of gesture mirroring for dichotomous referents for mapping selection.

FIG. 8 shows resulting gesture-referent map which is conflict-free and covers 59.4% of all the gestures and enabled by GestOnHMD. The gestures on the front and the right surfaces were more frequently used than those on the left surface. This could be because most of the participants were right-handed, with only two left-handed. Noted that there are three pairs of candidature gestures for fast forward/backward. The inventors considered all of them as reasonable mappings, with the same appearance frequency.

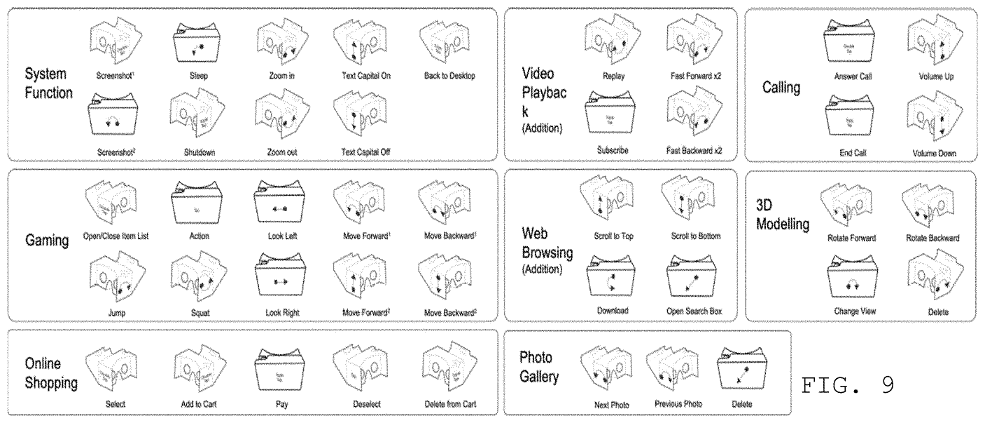

Beside the gesture-referent mappings for the two selected mobile VR applications, in total 74 pairs of gesture-referent mappings were collected for other referents in video playback (8), web browsing (5), and other applications (e.g., system functions: 11, calling: 4, photo gallery: 5, 3D modeling: 11, online shopping: 20, and gaming: 11). For these sets of gesture-referent mappings, the same conflict-resolving solution was adopted as for the 20 selected referents above. The inventors also considered the mappings proposed for system functions higher priority, to solve the conflict between system functions and applications. This resulted in the mappings shown in FIG. 9, covering 87.9% of the proposed gesture set enabled by GestOnHMD.

The above results showed that the GestOnHMD pipeline could recognize 33 on-surface gestures for Google Cardboard, and support a wide range of applications. The inventors devised that the embodiments may be further improved based on signal quality, robustness improvement, user-specific optimization, gesture design, device generalization.

During the gesture-selection process, the SNR level for each gesture was calculated using the recorded background noise which can be considered as a moderate level, similar to the environments with light traffic. For the model training, the acoustic gesture signals recorded in the quiet sound studio were mixed with the noise from an office environment. The SNR levels for the gestures may vary in other common noisy environments, and this may affect the model performance of gesture detection and recognition. During the experiments, it was observed that the SNR level may vary when users perform the on-surface gestures with different parts of their fingers. Generally speaking, the fingernail could generate the highest SNR level, while the finger pad tends to result in a softer acoustic signal. When collecting data set, the participants were encourage to use their fingernails as much as possible, to ensure the strengths of the signals.

The system's robustness towards noise can be improved with a larger data sets covering a wider range of background noise. In addition, various noise-reducing approaches have been proposed for speech recognition and sound-based activity recognition. It is worth to investigate the feasibility of these approaches being adopted in GestOnHMD. On the other hand, there have been commercial products of background noise-canceling microphones integrated into the headsets. It is reasonable to envision that such hardware can be minimized in shape and integrated into the smartphone in the future, which could potentially improve the quality of the acoustic-based mobile interaction.

Alternatively, the built-in noise-cancelling microphone may be used as an input of the detector module. For example, a smartphone with such function may be provided with a primary microphone at the bottom of the device, while the noise-cancelling/auxiliary microphone may be provided at the top edge of the device, such that when the smartphone is combined with the cardboard VR housing, the two microphones are positioned on the left and the right sides of the VR HMD apparatus when the smartphone is in a landscape orientation.

One potential issue with any prediction technique is addressing or correcting the errors. One type of error that may likely occur is the ambient sound generating as the false positives for gesture detection. The empirical experiments showed that GestOnHMD can perform robustly against the sound of random hand actions.

However, in an alternatively embodiment, user's gestures such as clapping hands and snapping fingers may also generates acoustic signals which are detectable by the microphones, and these common gestures may also be trained in the neural network or signal processor, and it associated with the database of the acoustic signals in the training sets.

Another potential solution for error handling could be introducing explicit correction/confirmation operation. For instance, with the presentation of the predicted gesture, the system can prompt an interface for the user to confirm or reject the prediction. One example for confirmation/rejection is through head nodding/shaking which could be detected based on the motion-sensor data. Yet, a high accuracy of gesture classification could reduce the need for explicit error correction.

In general, users preferred simple gestures (e.g., tapping and short sliding). Across the three surfaces, tap, double taps, and triple taps were the top three rated in terms of ease to perform and social acceptance. The gesture of sliding down yielded the lowest rating of fatigue, as it was the lower the better for fatigue. Tap and double taps were rated within the top 5 for low fatigue.

Looking at the gestures being removed due to low user preference, most of them involve either >1 directions (e.g., arrows), long-distance (e.g., circles), or complex shapes (e.g., star, wave, X, +, etc.). In previous work on user-defined gesture for surface computing and mobile devices, users tended to the gestures with shape drawing on the surface or in the mid-air, such as drawing circles, letters, and symbols. This was different from observations in the user-defined gesture for GestOnHMD. One possible reason is that users performed the gestures on the Cardboard surfaces in an eyes-free manner, which may affect their confidence in correctly performing the gestures. Therefore, simple gestures were more preferred.

For the signal strength, it was observed that tapping yielded louder sounds than sliding did, as tapping is usually quick and short. Gestures on the front surface generated stronger acoustic signals than those on the two sides. This phenomenon could be mainly due to the distance from the gesture surface to the stereo microphones. As discussed above, the participants may find it less smooth to perform the gestures on the front surface, so there may be a trade-off between the signal strength and the actual ease to perform. To this end, both user preferences and signal strength should be taken into account for on-surface gesture design.

The inventors only experimented with the acoustic gestural signals which were collected on the surfaces of Google Cardboard (2nd Generation). The surfaces of Google Cardboard are usually rough and thick, which may enhance the signal quality. As the design of Google Cardboard is open source, there are many design variations of paper-based mobile VR headsets in the market. Some are with glossy surfaces, and some are with tactile patterns, and therefore these may result in softer acoustic gestural signals. However, as appreciated by a person skilled in the art, the HID may be optimized by collect, analyze, and classify the acoustic gestural signals from different processed surfaces for GestOnHMD.

The inventors devise that it is possible to run the deep-learning models directly on the phone or it may be alternatively dun on a remote computer server due to the model complexity and the computational constraint on the smartphone. For example, it may be feasible to leverage the advantage of modern high-speed mobile networks (e.g., 5G cellular network). In addition, the modern deep-learning-based mobile applications could benefit from the hybrid approach of combining the on-device and the cloud-based classification. More specifically for GestOnHMD, the light-weight gesture-detection process may be run in real-time locally on the phone, since this process requires less computational resources than the other two following processes. The acoustic signal could be simultaneously sent to the cloud server for the face and the gesture recognition through the cellular network (e.g., 5G) in low latency. In addition, the GestOnHMD package and resource may be compatible with the popular VR development platforms (e.g., Unity and Unreal engines).

These embodiments may be advantageous in that the GestOnHMD, a novel gesture-based interaction technique for mobile VR is provided by simply using the built-in stereo microphones. A deep-learning-based three-step gesture-recognition pipeline is provided, with a real-time prototype of GestOnHMD being tested and evaluated.

Advantageously, a set of user-defined gestures may be performed on different surfaces of the Google Cardboard or other VR HMD, with the consideration on user preferences and signal detectability. Through online participatory design sessions, a set of gesture-referents mappings for a wide range of mobile VR applications may also be developed.

In addition, the gesture-elicitation studies resulted in a set of in total of 150 user-defined gestures for the front, the left, and the right surfaces for the Google-Cardboard headset., and the gesture sets may be narrowed down with the consideration of user preference and signal detectability, resulting in 15 gestures, 9 gestures, and 9 gestures for the front, the left, and the right surfaces respectively in a preferred embodiment.

It will be appreciated by persons skilled in the art that numerous variations and/or modifications may be made to the present invention as shown in the specific embodiments without departing from the spirit or scope of the invention as broadly described. The present embodiments are, therefore, to be considered in all respects as illustrative and not restrictive.

It will also be appreciated that where the methods and systems of the present invention are either wholly implemented by computing system or partly implemented by computing systems then any appropriate computing system architecture may be utilized. This will include stand-alone computers, network computers and dedicated hardware devices. Where the terms “computing system” and “computing device” are used, these terms are intended to cover any appropriate arrangement of computer hardware capable of implementing the function described.

Depending on the embodiment, certain acts, events, or functions of any of the algorithms, methods, or processes described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially.

Although not required, some aspects of the described embodiments (e.g. some of the image processing and/or object tracking processes) can be implemented as an Application Programming Interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

1. A method of controlling a virtual-reality (VR) head-mounted display (HMD) based on gestures, comprising steps of:
recording an acoustic signal received by a detector module of the VR HMD associated with a gesture performed by a user on a surface of the VR HMD;
mapping the recorded signal against a database storing a set of predefined user commands; and
executing one or more instructions thereby controlling an operation of the VR HMD.

2. (canceled)

3. The method of claim 1, wherein the gesture includes at least one of touching, tapping, swiping and drawing a predetermined pattern on the surface.

4. The method of claim 3, wherein the acoustic signal is generated by the surface and is further detected by one or more microphones.

5. The method of claim 3, wherein the surface is a front surface, a left surface or a right surface of a housing of the VR HMD.

6. The method of claim 1, wherein the acoustic signal is generated by at least one of clapping hands and snapping fingers which generates acoustic signal detectable by the one or more microphones.

7. The method of claim 1, wherein the step of recording the signal comprise the step of recording a first acoustic signal and a second acoustic signal detected at each of a left side and a right side of the electronic device.

8. The method of claim 1, wherein the step of mapping the recorded electronic signal against a database storing a set of predefined user command comprises the step of processing the recorded signal using a deep neural network trained with the set of predefined user commands and previously recorded signals.

9. A human-interface-device (HID) a virtual-reality (VR) head-mounted display (HMD), comprising:
a detector module arranged to receive and record an acoustic signal associated with a gesture performed by a user on a surface of the VR HMD;
a signal processor arranged to map the recorded signal against a database storing a set of predefined user commands; and
a HID controller arranged to execute one or more instructions thereby controlling an operation of the VR HMD.

10. (canceled)

11. The human-interface-device of claim 9, wherein the gesture includes at least one of touching, tapping, swiping and drawing a predetermined pattern on the surface.

12. The human-interface-device of claim 11, wherein the acoustic signal is generated by the surface and is further detected by one or more microphones.

13. The human-interface-device of claim 11, wherein the surface is a front surface, a left surface or a right surface of a housing of the VR HMD.

14. (canceled)

15. The human-interface-device of claim 9, wherein the acoustic signal is generated by at least one of clapping hands and snapping fingers which generates acoustic signal detectable by the one or more microphones.

16. The human-interface-device of claim 9, wherein the detector module comprises a first microphone and a second microphone arranged to record a first acoustic signal and a second acoustic signal detected at each of a left side and a right side of the electronic device.

17. The human-interface-device of claim 16, wherein the first microphone and the second microphone are mounted on the left side and the right side of the VR HMD.

18. The human-interface-device of claim 9, wherein the detector module comprises a stereo microphone or an array of microphones arranged to record a first acoustic signal and a second acoustic signal detected at each of a left side and a right side of the VR HMD.

19. The human-interface-device of claim 9, wherein the signal processor is arranged to process the recorded signal using a deep neural network trained with the set of predefined user commands and previously recorded signals.

20. A virtual-reality (VR) head-mounted display apparatus comprising:
a housing adapted to be mounted to the head of a user; and
a HID in accordance with claim 9.

21. The apparatus of claim 20, wherein the detector module comprises one or more microphones arranged to record a first acoustic signal and a second acoustic signal detected at each of a left side and a right side of the housing, and wherein the first acoustic signal and the second acoustic signal are generated upon the user performing the gesture.

22. The apparatus of claim 21, wherein the gesture includes at least one of touching, tapping, swiping and drawing a predetermined pattern on one or more surfaces of the housing, and/or at least one of clapping hands and snapping fingers which generates acoustic signal detectable by the one or more microphones.

23. The apparatus of claim 21, wherein the one or more microphones includes a stereo microphone, an array of microphones or a pair of microphones each being mounted respectively on the left side and the right side of the housing.
